(19) United States
(12) Patent Application Publication
(10) Pub. No.: US 2008/0025692 A1
(43) Pub. Date: Jan. 31, 2008

(54) Non-linear editing system with portable digital recording media

(76) Inventors: Yue Lu, Beijing (CN); Xiao Zhang, Beijing (CN)

Correspondence Address: IPFortune LLC/Ruay Lian Ho;Suite 400, 1700 Pennsylvania Ave., N.W., Washington, DC, 20006, US

(21) Appl. No.: 11/495,578

(22) Filed: Jul. 31, 2006

(51) Int. Cl. H04N 5/93

(52) U.S. Cl. 386/52

(57) ABSTRACT

A non-linear editing system with a portable data disc and a data editing recorder is provided for use in broadcast industry or professional applications. A data disc inserted into a data disc recording unit coupled with a video camera can directly collect and store data. The data disc removed from the recording unit can be inserted into a data editing recorder and the data, without transferring from the data disc to a hard disk inside the data editing recorder, can be edited directly by and stored back to the data disc after editing. Hot swapping connectors plus a newly developed guiding groove and guiding track are utilized to ensure the compatibility and interoperability of the data disc throughout the entire non-linear editing system.

### FIELD OF THE INVENTION

The present invention relates to a non-linear video editing system for use of broadcast industry or professional applications. Particularly, the present invention relates to a portable and compatible digital data recording medium for a non-linear data editing system.

### BACKGROUND OF THE INVENTION

Video data, such as a movie or a TV program, editing has evolved from mechanical editing to linear editing, then to the contemporary digital non-linear editing while the recording media have evolved from Video Tape Recorder (VTR) to Compact Disc (CD), then to Hard Disk (HD) and Semiconductor Disk. Currently, the commonly used tape editing systems include VHS, S-VHS, U types, 8 mm, Hi8, Betacam, Betacam SP, Betacam SX, Digital-S, DVCAM, DVCPRO, DVCPRO 50, MPEG IMX, HDCAM, and DVCPRO HD etc.

Although tape as a portable recording medium to some degrees solves the portability and compatibility problems of video data editing, the tape linear editing has many deficiencies, such as hard to change video data sequences, making alterations, time consuming, and low efficiency when searching for or skipping a particular clip. Most of all, searching and skipping video clips can easily damage the tape. That is why the video data editing is later done electronically.

Electronic editing is characterized in that video data are sequentially stored; the editing job is performed by forwarding and rewinding the tape. Once the editing is finished, any necessary alternation will cause the entire tape to be recorded all over again because the length of the tape cannot be changed. This is called the linear editing method. Configurations of typical linear editing systems are shown in FIG. 1 and FIG. 2. FIG. 1 shows a one-to-one tape editing system and FIG. 2 shows the two-to-one A/B special effect editing system. Of course, there still are two-to-one, multi-to-one editing systems and many more.

Because of the many deficiencies, linear editing has been replaced by non-linear editing overwhelmingly. Non-linear editing gives editors the freedom over skipping, saving, and retrieving video data without being restricted by the time sequences. However, the digital non-linear editing only constitutes a fraction of the entire editing process in modern day film making. Specifically, the video data have to be collected by tapes at first; afterwards, the video data are transferred into a computer hard disk where the non-linear editing can be performed. After editing, the video data need to be transferred back to the tapes for the purpose of playing because the video data storage, the computer hard disk, is part of the editing equipment, not a portable recording medium.

Unfortunately, the hard disk used for video data non-linear editing is not a recording medium as portable as the tape even though the time sequence constraint on video data editing has made a breakthrough. Hence, when various computer technologies, multi-media and video signal compressing techniques have been widely developed and have become applicable in entertainment business for film making, a non-linear editing system that can be coupled with a portable digital recording medium, such as a data disc, has become dire in need. A portable data disc compatible with various video cameras and data editing recorders not only improves the efficiency of a non-linear editing system but also lowers the production cost for entire film making industry by simplifying the editing process.

### SUMMARY

Accordingly, a non-linear editing system with a data editing recorder is provided by the present invention. This data editing recorder is compatible with other currently available non-linear editing systems and is capable of performing all the contemporary non-linear editing with fewer steps, higher efficiency.

Further, a portable digital recording medium compatible with various video cameras for collecting data and with various data editing recorders, including the data editing recorder provided by the present invention, for performing non-linear editing is also provided by the present invention. This portable digital recording medium is called a data disc. The portable data disc is first inserted into a data disc recording unit, which is coupled with a video camera for collecting video data. The data disc is then removed from the video camera and the data disc recording unit and inserted into a data editing recorder of a digital non-linear editing system for data editing.

Both the video frequency and the audio frequency of the video data are recorded by the coupled video camera and are stored on the portable data disc. The data disc can be made of a computer hard disk or a semiconductor disk or other later developed similar storage materials. Data reading and writing is done magnetically or electronically without direct contacting the data disc, contrary to the tape linear editing, which has data reading and writing done by repeatedly scratching the tape.

Therefore, it is an object of the present invention to provide a data disc for recording and editing data digitally. Both the video and the audio frequencies of the video data are stored in the data disc as regular digital files, which can then be processed by the file management of a computer operating system. The video data files are now possessed of the compatibility of regular digital files stored in digital systems. The video data files will not lose this compatibility even when the data disc is made of other types of materials. Further, there will be no friction resulted from data reading and writing process as a tape is used in a linear editing system. Undoubtedly, the video data on a data disc will last longer than the video data recorded on types.

It is another object of the present invention to provide a data disc to record data non-linearly and to edit the data non-linearly. The video data are recorded onto a data disc based on their localities and time sequences. Particularly, the video data localities and sequences are not related to the physical locations of the recording medium. As a result, the video data can be edited easily and non-linearly by quickly and symbolically editing the stored display sequences. In other words, the initial non-linear storage of the video data makes the later non-linear editing work a lot easier.

Furthermore, the insertion and removal of the data disc into and from a data editing recorder or other type of non-linear editing systems are achieved by utilizing the commonly used connecting standards, which includes, but not limited to, SATA, USB, IEEE 1394 or ATA. Because the data disc does not require a separate reading and writing transducer or another recording medium of any kind to complete its reading and writing process, the compatibility of the data disc does not depend on the made-of materials. The data disc and the data editing recorder will not become obsolete as long as the connecting standards are still utilized by the industry.

In addition, the data disc is equipped with hot swapping mechanism, and thereby the data disc can be hot swapped (also known as hot-plugged) into a video camera and later removed from it. The data disc can also be inserted into a data editing recorder of a non-linear editing system for data editing by utilizing the hot swapping mechanism. After insertion, the data disc can be recognized by the operating system right away and the data processing, for example, video data editing, can be performed immediately. The hot-swappable capability of the data disc further illustrates the portability and compatibility of the data disc.

Furthermore, a guiding groove with corresponding guiding track is provide to ensure the data disc smoothly inserted into a data disc recording unit or a data editing recorder. A locking mechanism is coupled with the guiding track to securely lock in the data disc when it is inserted and reached the final position within a data disc recording unit or a data editing recorder. For the case of a Lan data disc, the disc is first inserted into a Lan data disc driver, then together is inserted into a Lan data disc recording unit. The guiding groove is provided at the Lan data disc and the guiding track is provided at the Lan data disc driver. Of course, the guiding track can be provided on the data disc recording unit instead of a data disc driver when other preferred embodiments are utilized.

Moreover, newly developed software with user friendly graphical interfaces is also provided to couple with the data editing recorder so that the data contained on the data disc can be edited directly and easily after the data disc is hot-swapped into the system. This newly developed video and audio frequency editing software is capable of directly accessing the data disc and performing video data editing. Nevertheless, the software does not spoil the completeness and independence of the video data contained therein. In other words, the original video data will be safely preserved on the data disc regardless how many times they have been accessed and edited.

### DESCRIPTION OF THE DRAWINGS

The present invention can be further described in details by combining the following attached drawings with the preferred embodiments:

FIG. 1 illustrates a prior art schematic diagram of a one-to-one editing system;

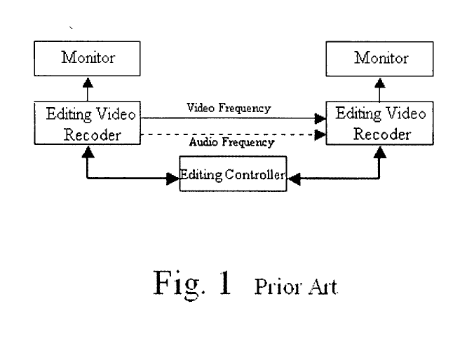

FIG. 2 illustrates a prior art schematic diagram of a two-to-one A/B special effect editing system;

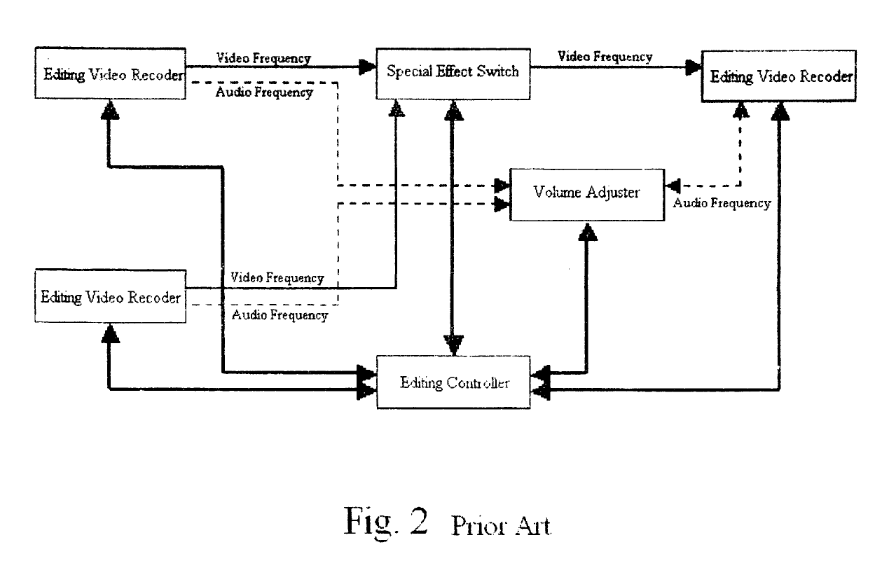

FIG. 3 illustrates an exemplary overall network incorporating the present invention;

FIG. 4 illustrates a preferred embodiment of the data editing recorder utilized in the present invention;

FIG. 5 illustrates the top view and the structural diagram of the control panel of a preferred data editing recorder provided by the present invention;

FIG. 6 illustrates a schematic diagram showing the system structures of the data editing recorder utilized in a preferred embodiment of the present invention;

FIG. 7 illustrates a preferred embodiment of the data disc recording unit of the present invention;

FIG. 8 illustrates the top and bottom views of the data disc recording unit utilized in a preferred embodiment of the present invention;

FIG. 9 illustrates the hot swapping mechanism of a preferred embodiment of a data disc recording unit;

FIG. 10 illustrates an outer case for a preferred embodiment of a data disc recording unit;

FIG. 11 illustrates a preferred embodiment of a data disc;

FIG. 12 illustrates sectional diagrams of a preferred embodiment of a data disc;

FIG. 13 illustrates a preferred embodiment of a data disc recording unit;

FIG. 14 illustrates a preferred embodiment of a data disc with guiding groove and sliding bar;

FIG. 15 illustrates another preferred embodiment for a Lan data disc recording unit;

FIG. 16 illustrates a structural diagram of a Lan data disc;

FIG. 17 illustrates a preferred embodiment of a Lan data disc driver;

FIG. 18 illustrates the back view of a preferred embodiment of a Lan data disc driver;

FIG. 19 illustrates a structural diagram of a Lan data disc inserted in a Lan data disc driver within a Lan data disc recording unit; and

FIG. 20 illustrates a video camera working with a Lan data disc recording unit.

### DETAILED DESCRIPTION OF THE INVENTION

A digital data recording medium called data disc and a data editing recorder are provided by the present invention. The data editing recorder is capable of performing non-linear editing on the video data stored on the data disc directly. Meanwhile, the data disc is compatible to video cameras and the data editing recorder of the present invention by utilizing a uniformed guiding groove. The guiding groove is used for insertion and removal of a data disc and for securing the connection to a data editing recorder and a data disc recording unit, which is compatible with video cameras.

Typically, the non-linear editing that does not edit the video data by arranging the physical storage locations of the video data according a time line is performed on the computer hard disk. An editor assembles the video data first by creating an Edit Decision List (EDL), which tells the playing system when to start and stop playing certain video clips. The editor can then select and preview the entire video data or in part until full satisfaction and the highest artistic visual effect are achieved. An EDL can then be decided and the final edition of the video clips is produced. Future editing also can be done conveniently if necessary.

For example, four different video clips A, B, C, and D are stored on the hard disk and occupies four different HD locations respectively. A new clip E is also stored on the hard disk and preferably to be stored between clips B and C. Because the non-linear editing changes the play sequence not the physical storage location, adding clip E is simply editing the EDL to include clip E in the play sequence right after clip B. In sum, the play sequence recorded in the EDL is now changed from ABCD to ABECD.

Besides those fixed and moving video data, visual and audio materials, such as subtitle and caption, and special effects can be added on, can be deleted or modified by the non-linear editing system. At the end of the editing, the editor creates an EDL containing the play sequence and completes the final version of the video ready for playing. At any time, a saved EDL can be loaded, which will erase the current EDL. If the chosen file is a video data file, then a new EDL will be created, bringing the start and stop points of the video data file into the newly created EDL. Furthermore, clips are indexed. After indexing, bits of information about the clips are stored in memory. This information is used to represent the clips visually in the EDL.

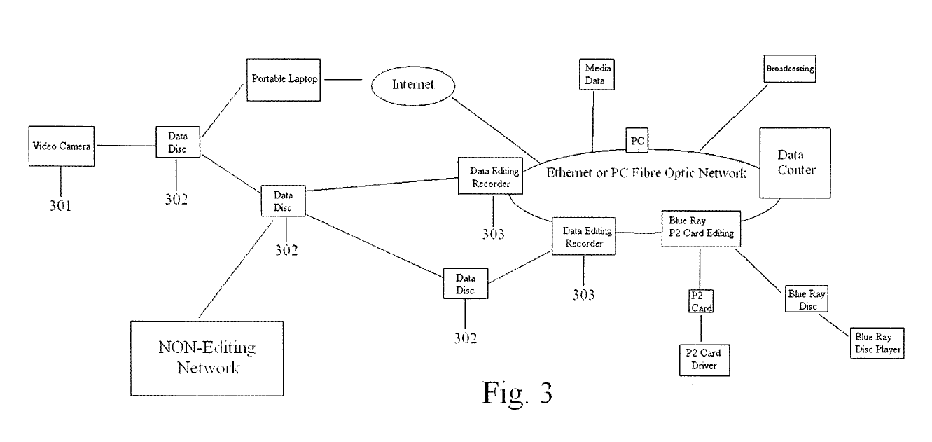

An overall network of a digital non-linear editing system of a preferred embodiment of the present invention is shown in FIG. 3. A video camera 301 collects video data and stored on a data disc 302, which is inserted in a data disc recording unit. Afterwards, the data disc is removed from the data disc recording unit and inserted into a data editing recorder 303 for editing. The video data can also be collected by blue ray disc, P2 card, or a non-editing network. The video camera 301 does not require any modification to be compatible and interoperable with a data disc recording unit having the data disc 302. However, it will take some adjustments for the data disc recording unit having the data disc 302 to interoperate with a laptop, which constitutes a portable editing unit.

Meanwhile, the entire system adopts a hot swapping mechanism to recognize new data disc that has just been plugged into a data editing recorder 303 and to activate the processes to edit the data contained therein. By the same token, a data disc recording unit has to be able to recognize a newly inserted data disc 302; a video camera needs to recognize a newly connected data disc recording unit and to activate the data collection process immediately after the connection. And, a uniformed guiding groove with corresponding guiding track is designed and utilized to realize the compatibility of the entire system. Specifically, the data disc 302 is formed with a guiding groove; the data disc recording unit and the data editing recorder are formed with guiding tracks to allow a data disc to slide in and get locked in after insertion.

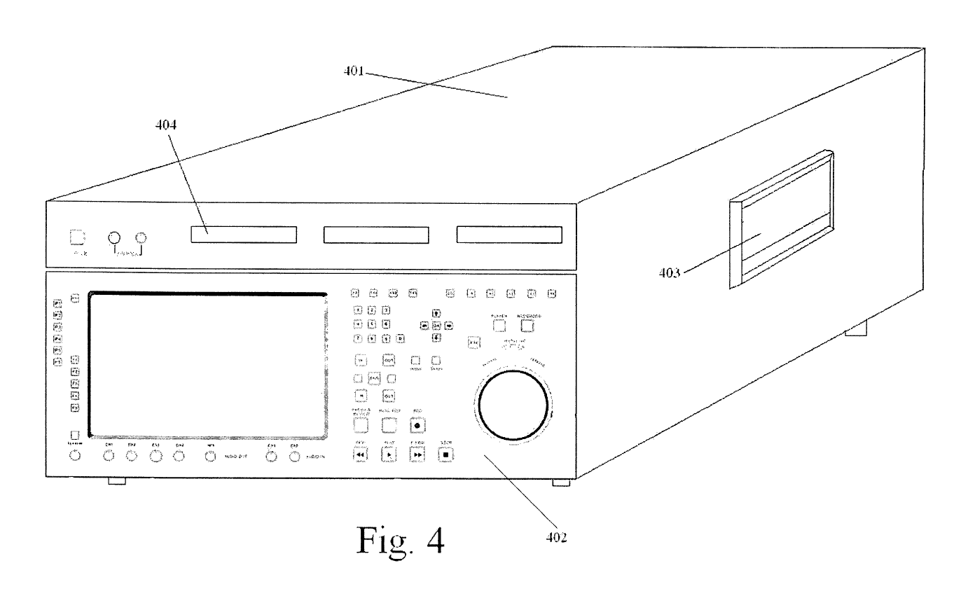

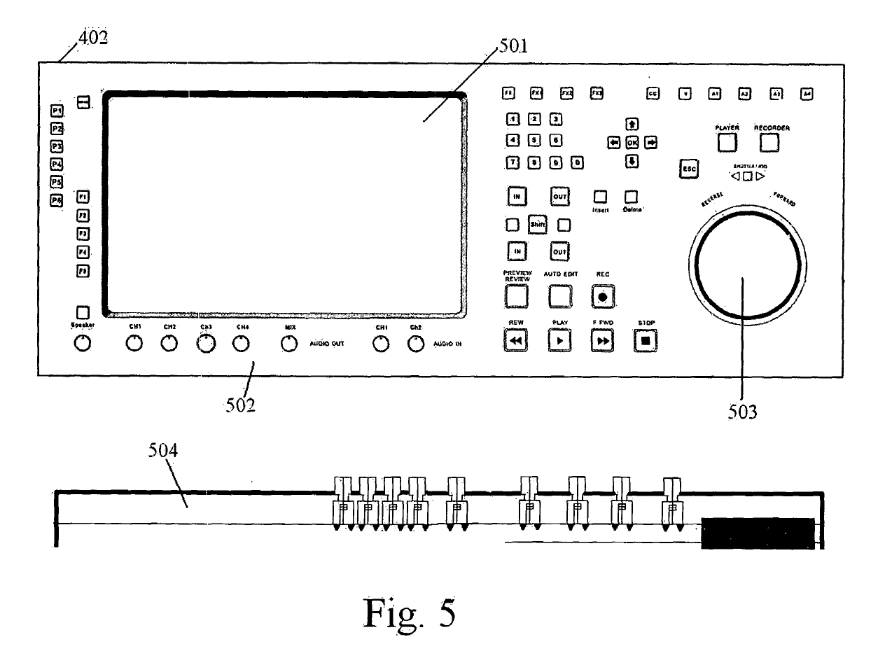

One of the preferred embodiments of the non-linear data editing recorder 303 is shown in FIG. 4. FIG. 4 illustrates a rectangular housing unit 401 with a control panel 402 at the front surface. Two handles 403 are formed on the two vertical side surfaces that flank the control panel 402. Three slots 404 for data disc 302 insertion are provided above the control panel 402 along with two earphone buttons and a power plug-in. The numbers of the disc slot can vary according to the operational needs. A further detailed diagram depicting the functions provided on the control panel is shown in FIG. 5.

Now referring to FIG. 5, the control panel 402 and its top view diagram 504 are disclosed. A display screen 501 is arranged at the left side of the control panel 402, some functional selection keys are arranged around the display screen 501. Volume controlling knobs 502 are installed underneath the display screen 501. On the left side of the control panel, a shuttle 503 surrounded by various functional selection buttons is provided for various editing operations.

Furthermore, newly developed software with friendly graphical user interface is also provided by the present invention to facilitate easy and efficient editing work. An editor can edit the video data by selecting or touching the various selection keys provided on the control panel 402 of the data editing recorder 303 or on the display screen 501 of the data editing recorder 303. Moreover, the editor can communicate with, or even remote control, other data editing recorders from the data editing recorder 303 of the present invention for necessary editing work or data exchange by way of the industry standards, such as SDI frequency or IEEE 1394.

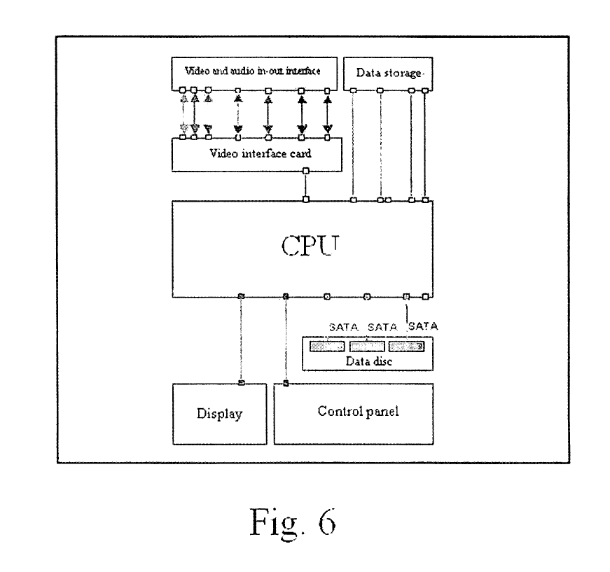

A schematic diagram showing the internal structures of a preferred embodiment of the non-linear data editing recorder 303 is illustrated in FIG. 6. A Central Processor Unit connects to and communicates with a display unit, a control panel, and a data storage device. A data disc 302 can be hot plugged into the system and communicate with the CPU by way of the Serial Advanced Technology Attachment (SATA) connector or other similar compatible connector. The video data stored in the data disc can be processed after the hot swapping plug-in like other data stored in the data storage device. Thereafter, the edited video data can be stored back to the data disc without destroying the originally saved data. The data disc later can be unplugged and re-plug into other digital non-linear editing system for data transfer.

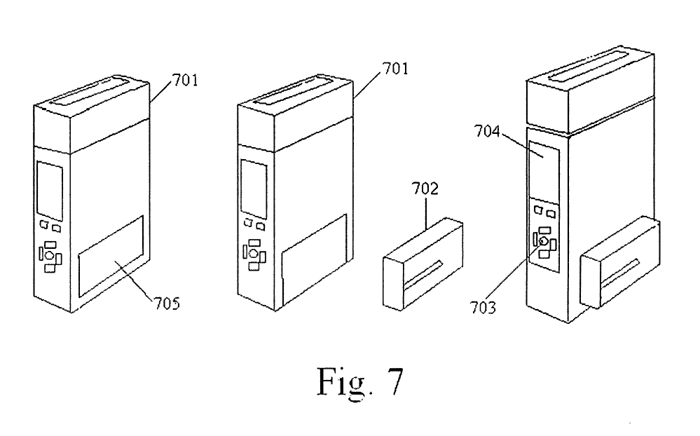

For data collecting, the data disc 302 has to be inserted into a data disc recording unit. The data disc recording unit can then be hot-swapped into the video camera 301. After data collecting, the data disc 302 can be inserted into the data editing recorder 303, which contains operational function keys and a display screen. The detailed structures and operational functions of a preferred embodiment of a data disc recording unit are disclosed in FIGS. 7-9.

One of the preferred embodiments of the data disc recording unit is shown in FIG. 7. A rectangular shape data disc recording unit 701 with a battery 702 enables the data disc recording unit 701 to operate independently without attaching to the power supply of a video camera. A control strip 703 is flanked by two vertical side surfaces of the data disc recording unit 701. A guiding concave groove, not shown in FIG. 7, is formed on the corresponding side surface of the control strip 703. A small display screen 704 is above the control strip 703, which has simple functions with respect to the contents and display of the data contained within the data disc. The battery 702 can be inserted partially into a concave window 705 located at the bottom of one large surface and is partially stuck outside the data disc recording unit 701. When the battery 702 is not inserted, the bottom concave 705 will be covered so that the data disc recording unit 701 has better appearances.

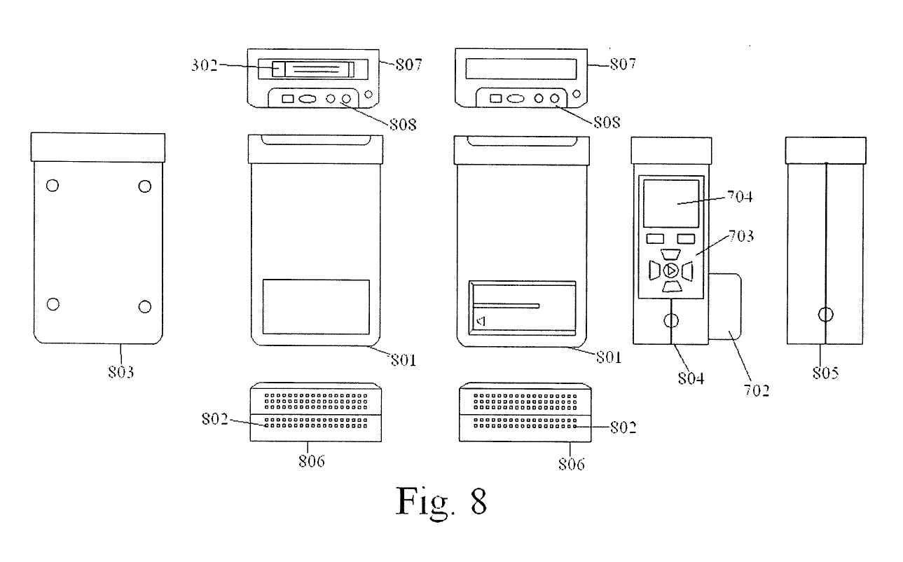

In FIG. 8, the six surfaces of a data disc recording unit 701 are shown individually. Now referring to FIG. 8, the two largest surfaces are shown in the middle of FIG. 8; and the surface capable of containing the battery 801 is disclosed with and without the battery plus its corresponding surface 803. The control strip 703 with the display screen 704 on a side surface 804 and its corresponding surface 805 are shown in the right side of

FIG. 8. The bottom surface 806 with apertures 802, which function as a vent for the data disc recording unit 701, is underneath the surface 801. The top surface 807 is shown with and without a data disc 302. Some functional connectors 808 are on the top surface 807 as well.

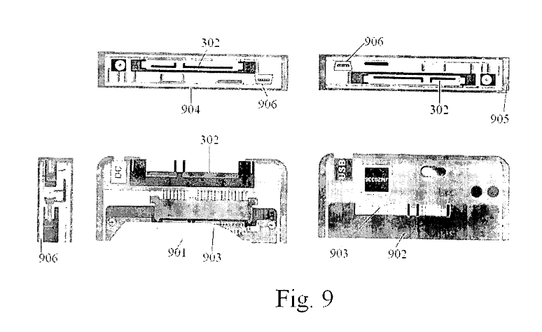

The structure and operational functions are further shown in FIG. 9. There are five surfaces sectional diagrams shown in FIG. 9. Sectional diagram 901 shows the major hot swapping function sector of the data disc recording unit 701. The corresponding side sectional view of diagram 901 is shown in diagram 906. After insertion, the data disc 302 inside the data disc recording unit 701 gets into contact with the hot swapping connector 903 that connects to a video camera. Data signals are transferred and stored into the data disc by way of the hot swapping connectors. Sectional diagram 902 illustrates the back view of the hot swapping connector 903 depicted in the sectional diagram 901. The side surface sectional diagram 904 corresponding to sectional diagram 901 illustrates a data disc 302 and a USB connector 906. Sectional diagram 905 is an illustration corresponding to the sectional diagram 902.

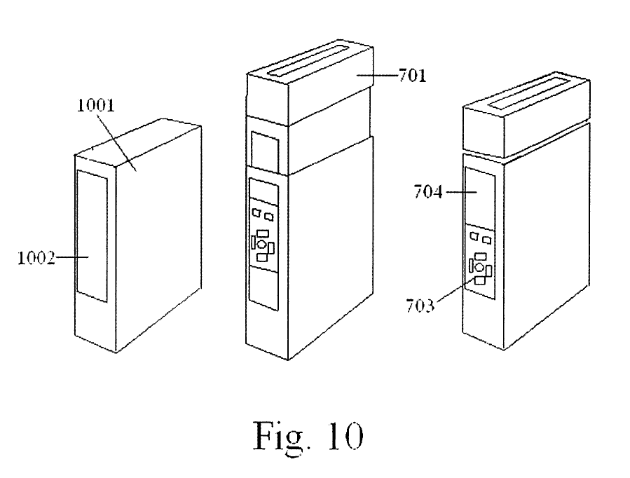

In addition, the data disc 302 within the data disc recording unit 701 can be further inserted into an outer case 1001. The rectangular shape outer case 1001 is shown in FIG. 10. The window 1002 on a side surface of the outer case 1001 reveals the display screen 704 and the control strip 703 of the data disc recording unit 701. The data disc recording unit 701 without a battery can snap fit into the outer case 1001. The outer case 1001 is utilized to harden the data disc recording unit 701 in order to prevent it from being crushed when appended to equipments, such as video cameras, which usually have external power supply.

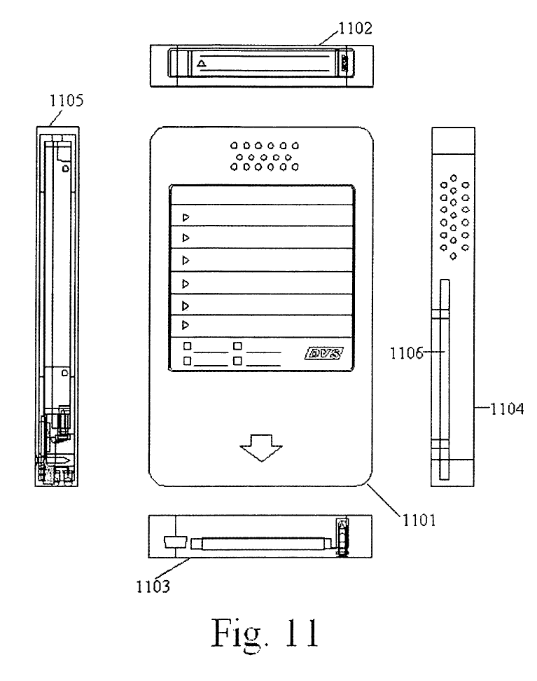

A preferred embodiment of the data disc 302 showing a front surface and four side surfaces is disclosed in FIG. 11. The front surface 1101 and the top surface 1102 have labels, which are utilized for specifying the contents of the data disc. Bottom surface 1103 shows the hot swapping connector for connecting to the corresponding hot swapping connector of a data disc driver or a data disc recording unit, which is then connected to a video recording camera for collecting data. The guiding groove 1106 is shown on side surface 1104 while the corresponding side surface 1105 shows the sectional internal structures of the data disc 302. The guiding groove 1106 serves as an insertion track when the data disc 302 is inserted into a data disc recording unit or a data editing recorder of the non-linear editing system of the present invention. After reached the final position the data disc 302 will be securely locked to the data disc recording unit or the data editing recorder by way of the guiding groove 1106. The guiding groove 1106, therefore, serves as the insertion and locking mechanism of the non-linear editing system of the present invention.

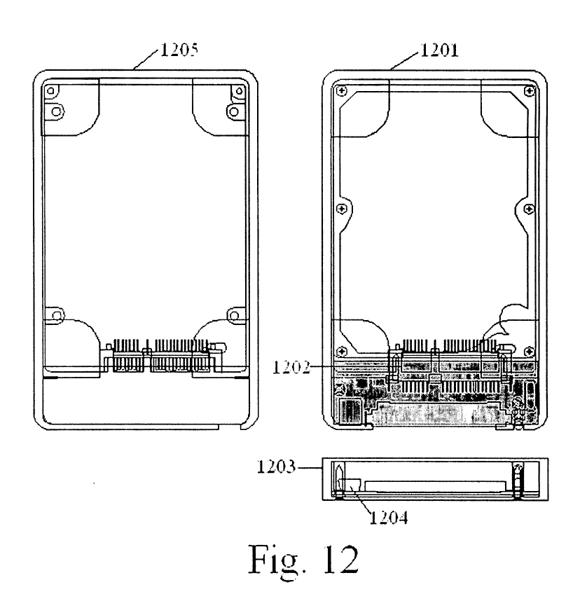

In FIG. 12 the hot swapping connector is further illustrated in details. The sectional diagram of surface 1201 contains the hot swapping connector 1202 at its front end that will first go into a device during insertion. The corresponding back view of surface 1201 is shown in surface 1205. Bottom side surface 1203 provides a different view of the hot swapping connector 1202. A USB connector at the left lower corner of the surface 1201 is shown in the corresponding left corner 1204 of surface 1203.

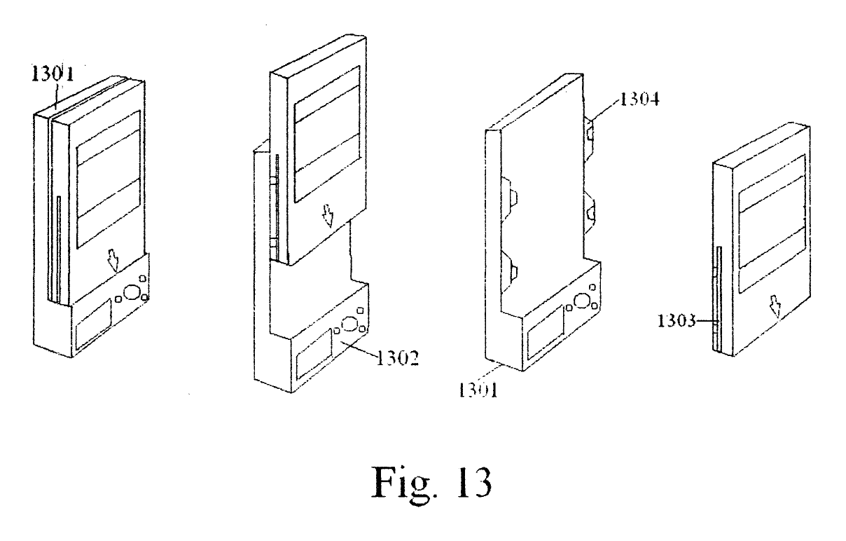

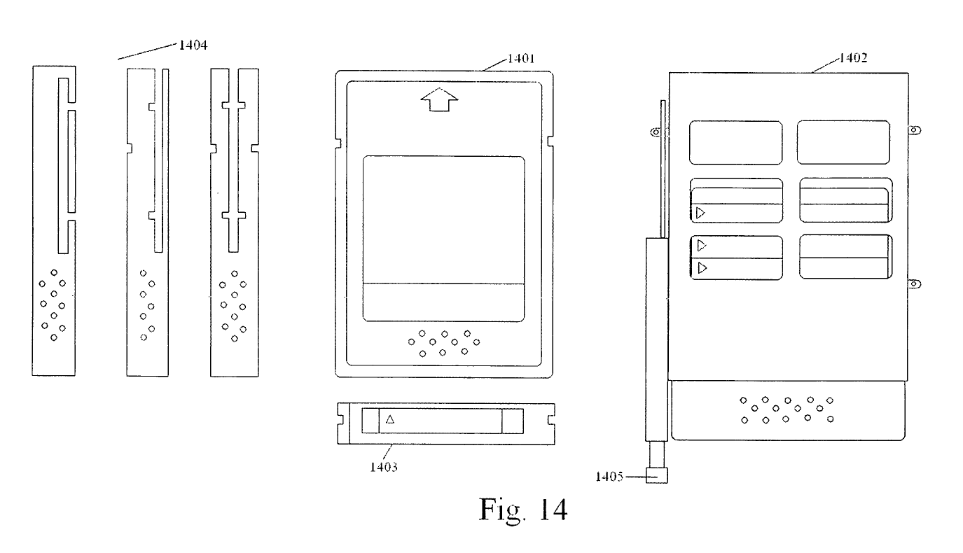

Another preferred embodiment of the data disc recording unit is shown in FIG. 13. An L-shape data disc recording unit 1301 with holders 1304 is utilized by the present invention. The guiding groove 1303 located at one side of the data disc 302 will guide the data disc to slide into the data disc recording unit 1301 during insertion. A control strip 1302 with display screen is arranged at the bottom of the data disc recording unit 1301. The data disc recording unit 1301 with an inserted data disc is also disclosed in FIG. 13. Further, the detailed guiding groove structure is shown in FIG. 14. Now referring to FIG. 14, a front surface with label 1401, a back surface with labels 1402, a push knob 1405 with a guide bar, and a top side surface 1403 are disclosed. Three different styles of guiding groove 1404 are also illustrated in FIG. 14.

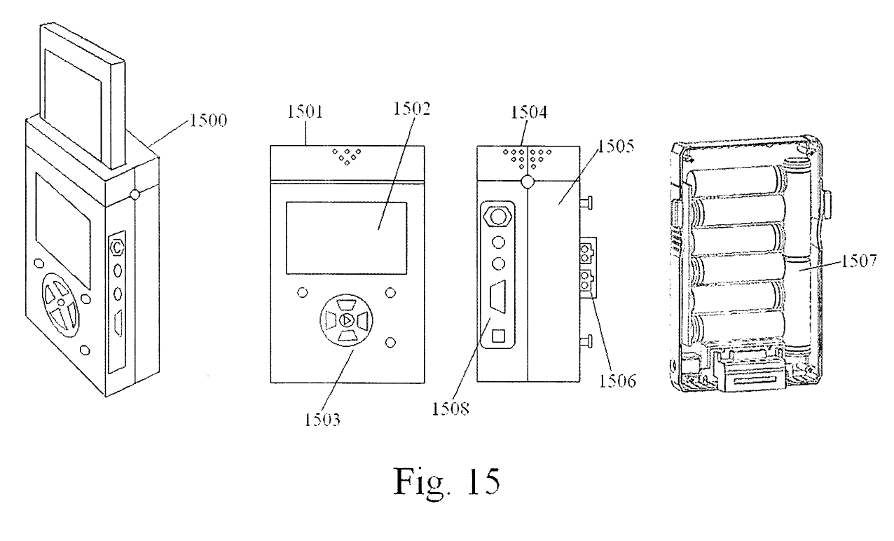

A third preferred embodiment 1500 of a data disc recording unit is illustrated in FIG. 15. Now referring to FIG. 15, a Lan data disc recording unit 1500 with a display screen 1502 and a control strip 1503 on its front surface 1501 is disclosed. The control strip 1503 has functions similar to the control strip 703 of the embodiment disclosed in FIG. 7. The side view 1504 of the data disc recording unit illustrates a battery portion 1505 at the back of the data disc recording unit 1500. The battery portion 1505 has a power output connector 1506 to video cameras; the internal arrangement of batteries 1507 inside the battery portion 1505 is also illustrated. A series of control buttons 1508 are provided at the data disc recording unit portion of the side surface 1504. The Lan data disc recording unit 1500 is coupled with Lan data disc.

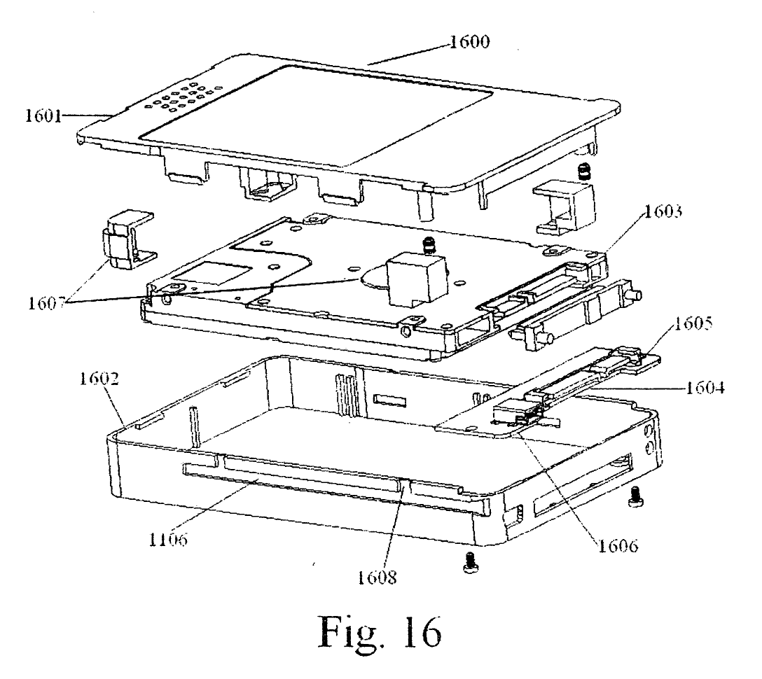

The detailed structure of a Lan data disc 1600 is illustrated in FIG. 16. The Lan data disc 1600 includes an upper cover 1601 and a lower housing unit 1602 with a storage entity 1603 in between. The housing unit 1602 and the upper cover 1601 can be made of plastic. The storage entity 1603 can be a hard disk or a semiconductor storage device. A SATA 1604 connector and a Universal Serial Bus (USB) 1605 connector are at the connecting circuit board 1606, which is located at the insertion fore end for hot swapping. Data signals get exchanged through these connectors. The USB2.9 and IEEE 1394 are standard data exchange connectors, which ensures the compatibility and interoperability of the Lan data disc 1600 to other devices or equipments of the non-linear editing system of the present invention.

Of course, if a Parallel Advanced Technology Attachment (PATA) is used as the storage entity, with built-in conversion circuit, the connectors at the connecting circuit board 1606 can still be utilized. Data exchanged through PATA will be transferred to SATA connector first, then, communicated to the non-linear editing system by way of USB. In addition, soft flexible supports 1607 are provided at the four corners of the storage entity 1603 so that the storage entity 1603 does not get in touch with any metal or plastic part of the Lan data disc 1600. The soft flexible supports 1607 plus the soft connecting wires adopted by the present invention provide a vibration proof mechanism for the Lan data disc 1600; as such, even external vibration cannot affect the storage and editing quality of the Lan data disc 1600. On the lower housing unit 1602, a guiding groove 1106 and a lock-in aperture 1608 are provided to secure the insertion and locking process.

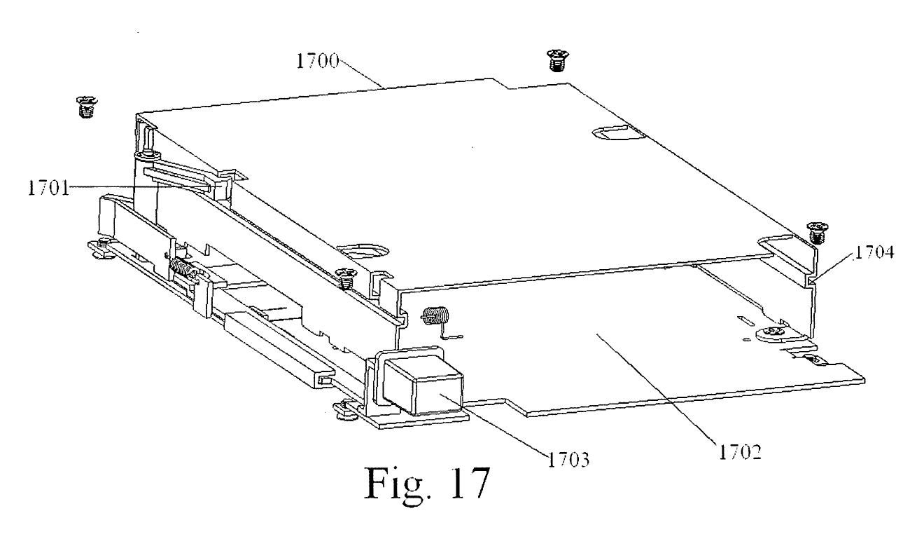

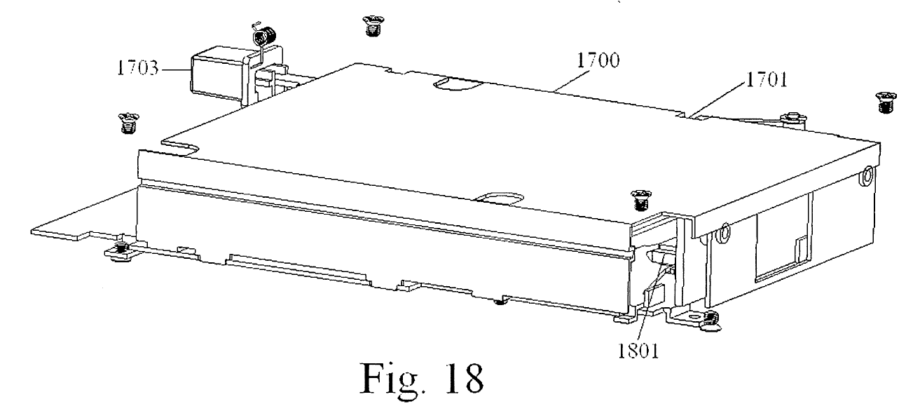

The Lan data disc driver 1700 for the Lan data disc 1600 is shown in FIG. 17 and FIG. 18. A front view of the Lan data disc driver 1700 is shown in FIG. 17. Looking at the Lan data disc driver 1700 from the Lan data disc 1600 insertion entry direction, a guiding track 1704 that corresponds to the guiding groove 1106 is formed at the right side of the Lan data disc driver 1700 and an EJECT key 1703 and a lock-in device 1701 are provided on the left side, a data disc holder 1702 is formed in the middle. The back view of the Lan data disc driver 1700 is shown in FIG. 18. The SATA connector 1801 is shown at the back of the Lan data disc driver 1700 and connects to the hot swapping connector of the Lan data disc recording unit 1500. The Lan data disc driver 1700 serves as an outer case for a Lan data disc 1600.

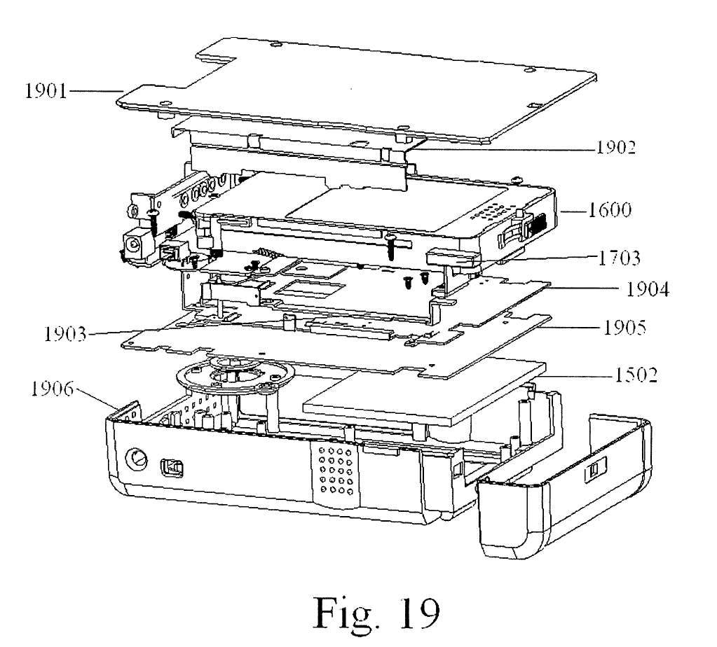

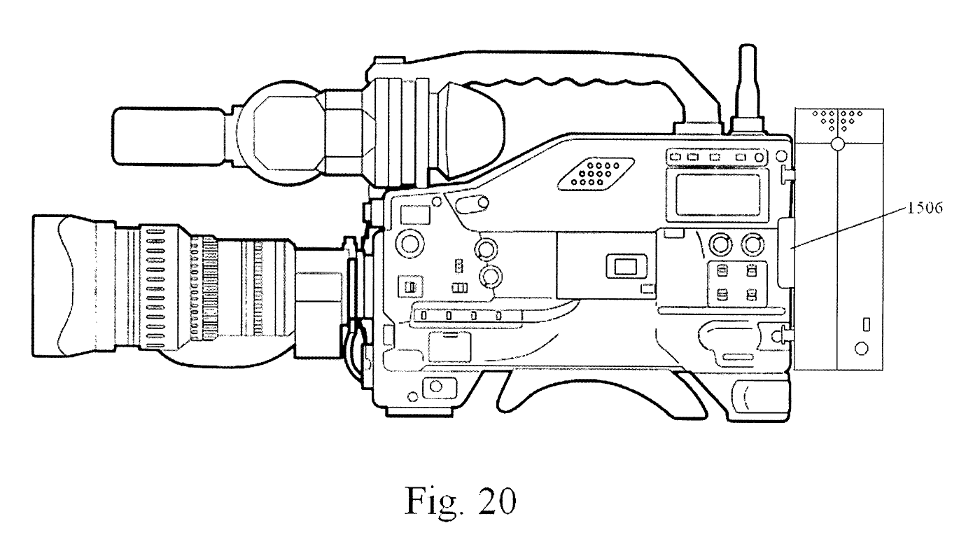

FIG. 19 illustrates the structures and relationship between the Lan data disc 1600 with its driver 1700 after they are inserted together. The exemplary embodiment of FIG. 19 includes an upper cover 1901 of the Lan data disc recording unit 1500, the Lan data disc driver upper cover 1902, the Lan data disc 1600, the Lan data disc driver lower container 1904, the main data processor 1905, a display screen 1502, the EJECT key 1703, a push bar 1903, and the front surface of the Lan data disc recording unit 1906. Finally, FIG. 20 shows a Lan data disc recording unit 1500 consisting of a Lan data disc 1600 wrapped with a Lan data disc driver 1700 attached to a video camera for data collecting.

Although the present invention has been described in certain exemplary preferred embodiments, many modifications and variations would be apparent to those skilled in the art. It is therefore understood that the present invention may be practiced otherwise than as specifically described herein. Hence, those preferred embodiments described in the present invention should be considered in all respects as illustrative and not restrictive.

What we claimed is:

1. A non-linear data editing system comprises:
a data editing recorder; and
a data disc that can be directly edited by the data editing recorder.

2. The non-linear data editing system as claimed in claim 1, wherein the data editing recorder further comprises:
a control panel; and
a plurality of slots for inserting the data disc.

3. The non-linear data editing system as claimed in claim 2, wherein the control panel of the data editing recorder further comprises:
a display screen;
a plurality of functional selection buttons; and
a software with user friendly graphical interface for editing.

4. The non-linear data editing system as claimed in claim 1, wherein the data editing recorder further comprises standard hot swapping connectors.

5. The non-linear data editing system as claimed in claim 4, wherein the hot swapping connectors are Serial Advanced Technology Attachment (SATA) and Universal Serial Bus (USB).

6. The non-linear data editing system as claimed in claim 1, wherein the data editing recorder further comprises a guiding track, which enables the insertion and lock-in of the data disc into the data editing recorder.

7. The non-linear data editing system as claimed in claim 6, wherein the data editing recorder is capable of directly editing the data contained on the data disc after the hot-swapping connection without transferring the data into a storage medium.

8. The non-linear data editing system as claimed in claim 3, wherein the data editing recorder is capable of communicating with other data editing recorders by way of industry standards or by remote control.

9. The non-linear data editing system as claimed in claim 1 further comprises a data disc driver.

10. The non-linear data editing system as claimed in claim 9 further comprises a data disc recording unit.

11. The non-linear data editing system as claimed in claim 10, wherein the data disc recording unit further comprises standard hot swapping connectors.

12. The non-linear data editing system as claimed in claim 11, wherein the hot swapping connectors are Serial Advanced Technology Attachment (SATA) and Universal Serial Bus (USB).

13. The non-linear data editing system as claimed in claim 11, wherein the data disc further comprises a guiding groove, which enables the insertion and lock-in of the data disc into the data disc driver.

14. The non-linear editing system as claimed in claim 13, wherein the data disc is wrapped by a data disc driver, and the data disc driver is inserted into a data disc recording unit, which is hot swapped into a video camera for data collecting.

15. The non-linear editing system as claimed in claim 14, wherein the collected data is stored in the data disc, which is then removed from the data disc recording unit and inserted into a data editing recorder with the data disc driver for direct data editing.

16. A non-linear data editing system comprises:
a data disc;
a data disc driver, wherein the data disc is inserted into the data disc driver; and
a data disc recording unit containing the data disc driver.

17. The non-linear data editing system as claimed in claim 16 further comprises hot swapping connectors utilized by the data disc and the data disc recording unit.

18. The non-linear data editing system as claimed in claim 17 further comprises guiding groove utilized by the data disc, and guiding track utilized by the data disc recording unit and the data editing recorder.

19. The non-linear data editing system as claimed in claim 18, wherein the data disc wrapped by a data disc driver then inserted into a data disc recording unit and hot swapped into a video camera for data collecting; and the data disc with a data disc driver are hot swapped into a data editing recorder for data editing without any data transfer required.

20. The non-linear data editing system as claimed in claim 16, wherein the data disc is made of hard disk or semiconductor disk.
